(19) United States
(12) Patent Application Publication
(10) Pub. No.: US 2013/0126232 A1
(43) Pub. Date: May 23, 2013

(54) WIRE HARNESS WATERPROOF STRUCTURE

(71) Applicant: Takashi Sakuma, Yokkaichi-city (JP)

(72) Inventor: Takashi Sakuma, Yokkaichi-city (JP)

(73) Assignee: SUMITOMO WIRING SYSTEMS, LTD., Yokkaichi-city, Mie (JP)

(21) Appl. No.: 13/812,345

(22) PCT Filed: Mar. 28, 2011
(86) PCT No.: PCT/JP2011/057598

§ 371 Date: Jan. 25, 2013

(30) Foreign Application Priority Data
Sep. 15, 2010 (JP) 2010-207245

(51) Int. Cl. H01B 7/282

(52) U.S. Cl. CPC H01B 7/282
USPC 174/72 A

(57) ABSTRACT

To prevent hardening of waterproofing portions of a wire harness and increase in outer diameter. A plurality of shielded wires having waterproofing portions in a wire bundle included in one wire harness are divided into a plurality of groups; the waterproofing portions are provided at different locations by group; and the waterproofing portions are provided at a predetermined distance from the waterproofing portions in another group so as to be disposed dispersedly in an axis direction of the wire harness.

### TECHNICAL FIELD

The present invention relates to a wire harness waterproof structure, in particular, a wire harness waterproof structure that prevents reduction in flexibility in a waterproofing portion and reduces increase in an outer diameter.

### BACKGROUND ART

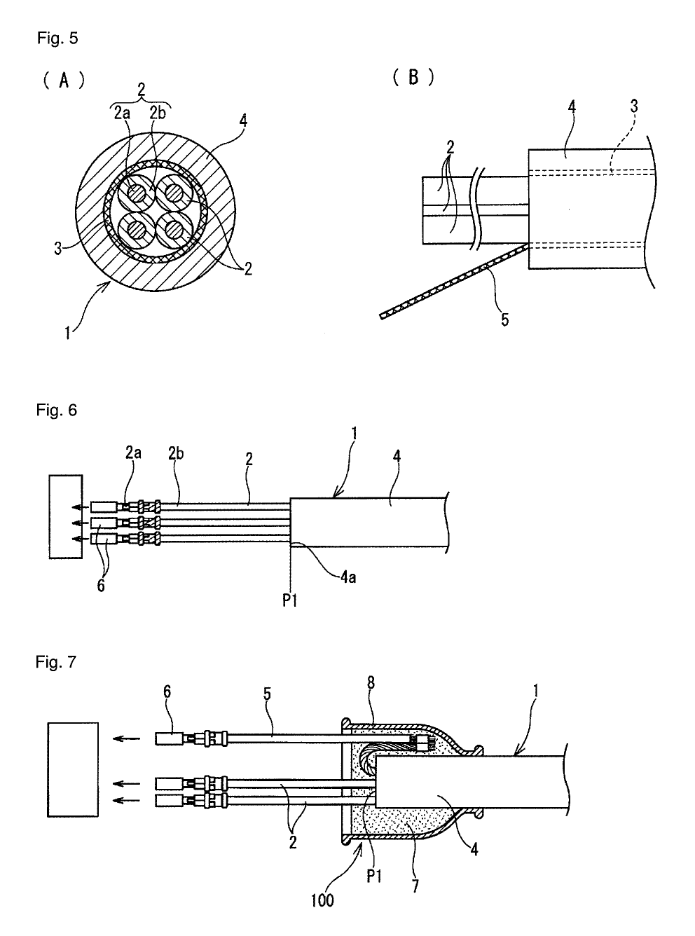

An increasing number of shielded wires are used for protection against noise in a wire bundle in a wire harness routed in an automobile. Such a shielded wire includes, as shown in FIG. 5, a plurality of core wires 2 (each wire having a strand 2a covered by an insulating cover 2b), a shielding layer 3, and an outer casing (sheath) 4. The core wires 2 serve as signal wires. The shielding layer 3 is a tube composed of a metal braided wire covering outer peripheries of the bundled core wires 2 or a metal foil tape wound around the outer peripheries. The outer casing 4 is an insulating resin layer provided on an outer periphery of shielding layer 3. Furthermore, in the case where the shielding layer 3 of the shielded wire 1 is provided by covering the metal braided wire, the shielding layer 3 is grounded through a drain wire 5 composed of a twisted metal braided wire pulled out from the front end, as shown in FIG. 5(B). In the case where the shielding layer 3 is provided by winding the metal foil tape, a strand in contact with the metal foil tape is provided to serve as a drain wire wired in parallel with the core wires 2.

A wire harness that includes the shielded wire is also routed in an area exposed to water, such as in an engine compartment of an automobile. In the area exposed to water, a waterproof connector is used to connect a wire and a device or wires to each other so as to prevent water from entering inside the connector. With the shielded wire, which includes a metal shielding layer thereinside, water should be prevented from entering inside the wire to prevent corrosion of the shielding layer. Specifically, in the shielded wire 1, as shown in FIG. 6, the outer casing 4 and the shielding layer 3 are cut off at a cut-off position P1 at a predetermined distance from a front end to expose the core wires 2. Then, the core wires 2 are cut off at a position at a predetermined distance from the front end to expose the strands 2a, which are connected to terminals 6.

When water enters between a cut-off end 4a of the outer casing 4 and a cut-off end of the shielding layer 3, between the cut-off end of the shielding layer 3 and the core wires 2, or between the core wires 2, water is sucked inside the shielded wire 1 due to a capillary action and is brought into contact with the shieling layer 3, thus leading to possible corrosion.

In order to prevent water from entering through the cut-off ends of the shielded wire 1, the shielded wire 1 is conventionally treated with waterproofing.

Such a method of waterproofing the shielded wire is disclosed in Japanese Patent Laid-Open Publication No. 2008-305634. With reference to FIG. 7, a waterproofing portion 100 is provided in which a tubular cap 8 filled with a waterproofing agent 7 composed of a thermoset resin covers a portion that includes the cut-off position P1. One end portion of the cap 8 covers the outer casing 4 while the other end portion covers a portion where the core wires 2 and drain wire 5 projecting from the cut-off position P1 are pulled out.

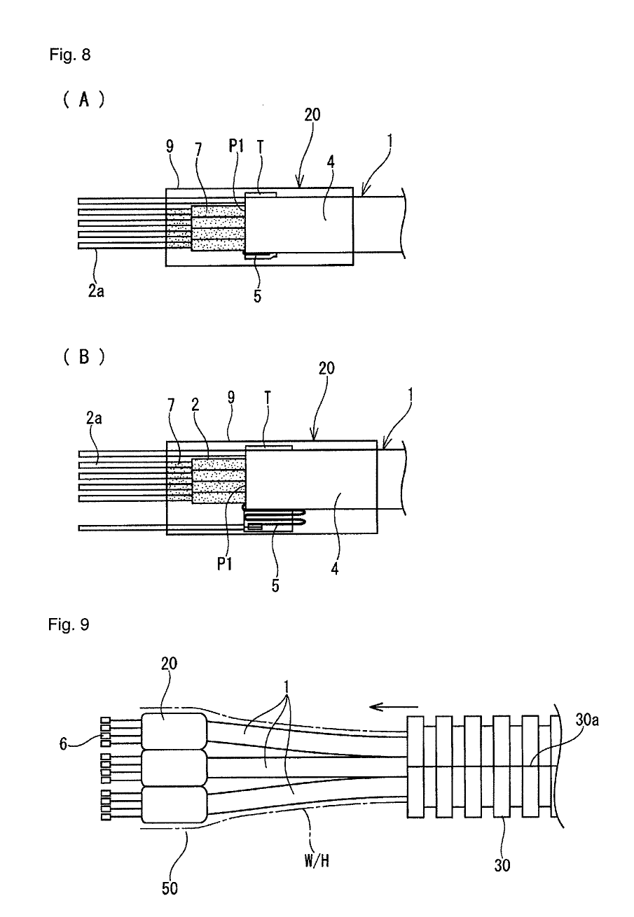

Furthermore, with reference to FIGS. 8(A) and (B), a waterproofing portion 20 is provided in which a predetermined section of the core wires 2 pulled out from the cut-off position P1 is filled with the waterproofing agent 7 and hardened; the pulled out drain wire 5 is folded over an outer peripheral surface of the outer casing 4, and then a tape T is wound around. Thereafter, a heat shrinking tube 9 is covered on a portion that includes the cut-off position P1 from the section filled with the waterproofing agent 7 to the outer peripheral surface of the outer casing 4, and is heat-shrunk to tightly fit to an outer peripheral surface of the filled section and to the outer peripheral surface of the outer casing 4.

### CITATION LIST

### Patent Literature [Patent Literature 1] Japanese Patent Laid-Open Publication No. 2008-305634

### SUMMARY OF INVENTION

### Technical Problem

In both of the conventional waterproof structures shown in FIGS. 7 and 8, the waterproofing portion is hard since the waterproofing agent 7 is hardened and the outer diameter of the wire increases.

The number of shielded wires in a wire bundle included in one wire harness W/H has been increasing. A distance from a connector connection portion of a wire harness terminal to the waterproofing portion is the same for all shielded wires. Thus, as shown in FIG. 9, waterproofing portions 20 of all shielded wires are concentrated in a location proximate to the connector connection position of the terminal of the wire harness H/W. This makes the wire harnesses difficult to bend in the concentrated waterproofing portion 50 and increases the outer diameter of the wire harness W/H.

When the concentrated waterproofing portion 50 needs to be bent in accordance with routing specifications of the wire harness W/H, there may be a situation where the wire harness W/H cannot be routed due to large curvature of the concentrated waterproofing portion 50 which is difficult to be bent. In addition, the outer diameter of the concentrated waterproofing portion 50 increases and thus causes a problem in which the wire harness W/H cannot be accommodated in an exterior material, which is a corrugated tube 30. In this case, increasing the size of the corrugated tube enables the wire harness W/H to be accommodated. However, the enlarged corrugated tube requires a space on a routing path. Furthermore, such a corrugated tube is too large for the outer diameter of the wire harness other than in the concentrated waterproofing portion 50 of the wire harness. This leads to a problem where a slit 30a in an axis direction of the corrugated tube 30 tends to open.

Moreover, waterproofing in the connector connection portion of the shielded wire terminal may also be provided to general wires other than the shielded wires routed in an area exposed to water. Concentration of waterproofing portions of the general wires in the same location makes the wire harness difficult to bend and increases the outer diameter.

The present invention is provided to address the circumstances above. An object thereof is to eliminate a concentrated waterproofing portion where waterproofing portions are concentrated in the same location so as to allow a wire harness to be routed in accordance with specifications without a portion where the wire harness is difficult to be bent and to prevent an outer diameter of the wire harness from partially increasing so as to eliminate necessity in increasing a size of a corrugated tube when the wire harness is accommodated in the corrugated tube as an exterior material.

### Solution to Problem

To address the circumstances above, the present invention provides a wire harness waterproof structure in which a plurality of shielded wires having waterproofing portions in a wire bundle included in one wire harness are divided into a plurality of groups; the waterproofing portions are provided at different locations by group; and the waterproofing portions are provided at a predetermined distance from the waterproofing portions in another group so as to be disposed dispersedly in an axis direction of the wire harness.

The predetermined distance from the waterproofing portions is preferably at least 50 mm or greater.

The waterproofing portions of the shielded wires are each filled with a waterproofing agent on cut-off end surfaces of a shielding layer enclosing a plurality of core wires of the shielded wires and an outer casing enclosing the shielding layer; and a heat shrinking tube is covered on an outer periphery including the cut-off end surfaces from the outer casing to a portion filled with the waterproofing agent.

The waterproofing agent filled in the waterproofing portions is composed of a hot melt or the like, which is hardened after a predetermined time from filling and makes the shielded wires difficult to bend.

As described above, the waterproofing portions are provided dispersedly in the axis direction of the wire harness. Thus, the wire harness can be easily bent, compared to a case where waterproofing portions are concentrated in one location. In addition, the outer diameter of the entire wire harness can be reduced, thus eliminating necessity of increasing the size of a corrugated tube as an exterior material. Furthermore, an area of 50 mm or greater between the groups where no waterproofing portion is provided is easily bent, thus increasing flexibility of the wire harness as a bend support of the wire harness.

Preferably, the distance between the groups is from 50 to 80 mm; and the number of groups is two.

The maximum number of the shielded wires having the waterproofing portions in one group is four to six. In a case where eight shielded wires are included in one wire harness, for example, the number of the shielded wires included in one group is four each.

The waterproofing portions of the plurality of shielded wires in one group are preferably provided at a predetermined distance apart in association with the length of the waterproofing portions. Specifically, the plurality of shielded wires in one group are preferably provided at approximately 10 mm apart from each other, in association with the length of a hardened portion filled with the waterproofing agent of the waterproofing portion.

However, in a case where a large number of the shielded wires are provided and a peeling length of the outer casing and shielding layer from the front end exceeds a set value, preferably two kinds of the shielded wires having the waterproofing portions at 10 mm apart from one another are provided in one group and the waterproofing portions provided at 10 mm apart are disposed in zigzag arrangement in a radial direction.

With the waterproofing portions, particularly the portions where the waterproofing agent is hardened, provided without overlapping in the radial direction in one group, the wire harness is easy to bend as a whole and a partial increase in the outer diameter is reduced.

In a case where waterproofing portions are provided to general wires other than the shielded wires by applying a waterproofing agent to a cut-off end of an insulating cover, preferably the general wires are divided into groups, along with the shielded wires; the groups are provided apart from one another; and the waterproofing portions are provided at different locations in the group.

### Advantageous Effects of Invention

As described above, the waterproofing portions of the plurality of shielded wires included in the wire harness are dispersed in the axis direction of the wire harness without being concentrated in one location. Dispersing the waterproofing portions, which are difficult to bend, prevents reduction in flexibility of the wire harness as a whole, even in a case where the waterproofing portions are difficult to bend with a hardened waterproofing agent, and thus allows the wire harness to be routed in accordance with specifications. In addition, dispersing the waterproofing portions, where the outer diameter increases, prevents a partial increase in the outer diameter of the wire harness as a whole, and thus eliminates necessity to increase the size of the corrugated tube through which the wire harness is inserted.

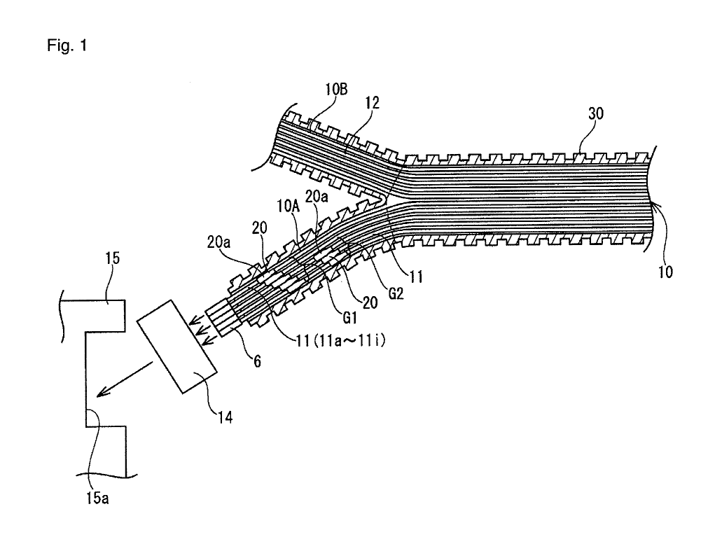

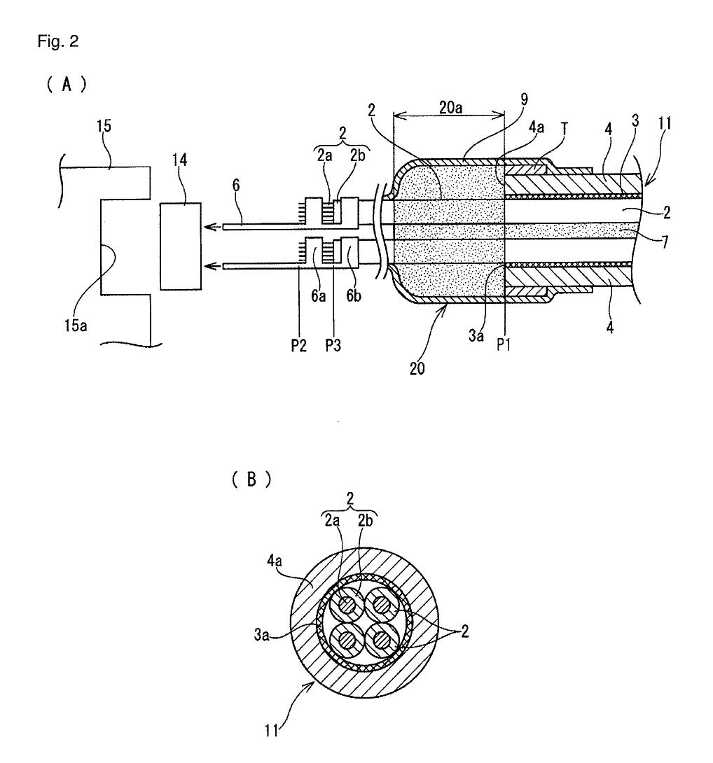

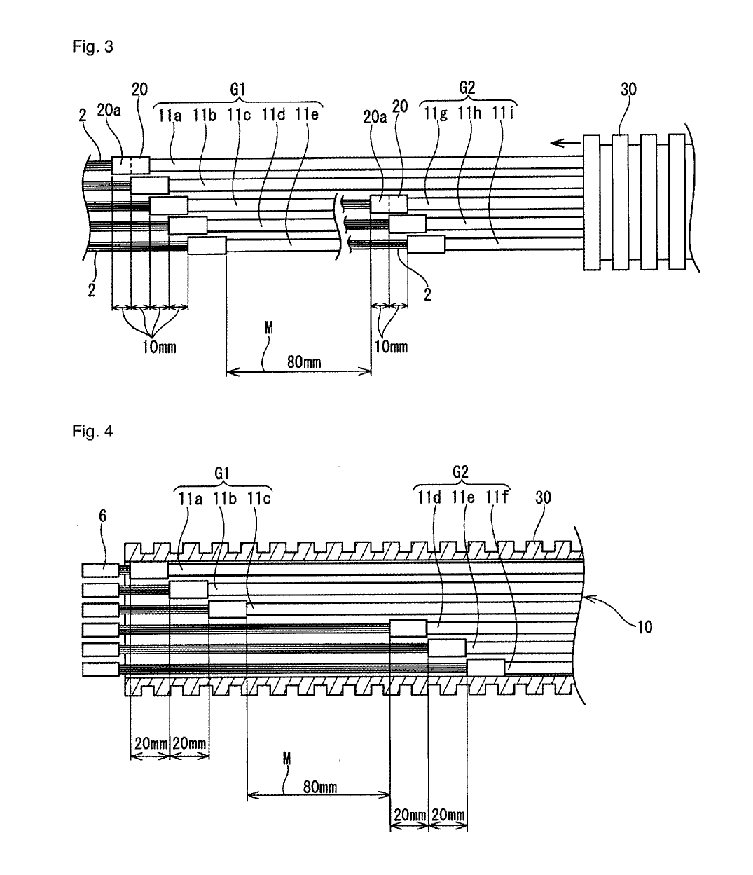

### BRIEF DESCRIPTION OF DRAWINGS

[FIG. 1] A view of a wire harness according to an embodiment of the present invention.

[FIG. 2] (A) A cross-sectional view of an enlarged main section of a shielded wire included in the wire harness; (B) A cross-sectional view at a cut-off position P1 in (A).

[FIG. 3] A view illustrating a location of a waterproofing portion of the wire harness.

[FIG. 4] A view illustrating a location of a waterproofing portion of a wire harness according to a modification of the present invention.

[FIG. 5] A view of a shielded wire; (A) A cross-sectional view; (B) A view of a drain wire formed of a shielding layer of a metal braided wire in the shielded wire.

[FIG. 6] A view illustrating a state where a connector is connected to a terminal of a shielded wire.

[FIG. 7] A view of a conventional waterproofing portion of a shielded wire. [FIG. 8] (A) (B) Views of another conventional waterproofing portion of a shielded wire.

[FIG. 9] A view illustrating a wire harness bundling shielded wires to indicate a conventional problem.

### DESCRIPTION OF EMBODIMENTS

An embodiment of the present invention is described below with reference to the drawings.

A wire harness 10 shown in FIG. 1 is routed in an engine compartment, which is an area exposed to water, of an automobile. A wire bundle included in the wire harness 10 includes a plurality of shielded wires 11 (eight wires in the present embodiment). The wire bundle also includes wires 12 other than the shielded wires 11. On one end of the wire harness 10, terminals of the eight shielded wires 11 are connected to a waterproof connector 14, which is connected to a connector fitting portion 15a of an ECU (electronic control unit) 15 mounted in the engine compartment. Another waterproof connector (not shown in the drawing) is connected to the general wires 12 other than the shielded wires 11. Specifically, the one end of the wire harness 10 branches into a branch wire 10A bundling the eight shielded wires 11 and a branch wire 10B of the other wire bundle.

Similar to FIG. 5, each of the shielded wires 11 connected to the waterproof connector 14 of the branch wire 10A includes four core wires 2 enclosed by a shielding layer 3 composed of a metal braided wire tube, the shielding layer 3 being covered by an outer casing 4, which is an insulating resin layer.

With reference to FIG. 2(A), in a waterproofing portion of the shielded wire 11, the shielding layer 3 and the outer casing 4 are cut off at a cut-off position P1 at a predetermined distance from a front end P2 of the shielded wire 11; the shielding layer 3 and the outer casing 4 are peeled off from the cut-off position P1 to the front end P2; and the core wires 2 are pulled out from a cut-off end 3a of the shielding layer 3 and a cut-off end 4a of the outer casing 4.

An insulating cover 2b of each of the pulled out core wires 2 is cut off at a cut-off position P3 at a predetermined distance from the front end P2 to expose a strand 2a. The exposed core wire 2a and the insulating cover 2b adjacent to the cut-off position P3 are crimped by barrels 6a and 6b, respectively, of a connector 6 for connection. Furthermore, a tape T is wound around an outer peripheral surface of the outer casing 4 along the cut-off position P1.

The shielded wire 11 is filled with a waterproofing agent 7 composed of a hot melt in gaps between the core wires 2 pulled out from the cut-off position P1 and on the cut-off end 3a of the shielding layer 3 and the cut-off end 4a of the outer casing 4. After the filled waterproofing agent 7 is hardened, a heat shrinking tube 9 is covered from the outer peripheral surface of the outer casing 4 to an outer peripheral surface of a location where the waterproofing agent 7 is filled so as to include the cut-off position P1 therebetween. The heat shrinking tube 9 is then heat-shrunk at a heat-shrinking temperature to tightly fit to the outer peripheral surfaces. Thereby, a waterproofing portion 20, which is filled with the waterproofing agent 7 and covered by the heat shrinking tube 9, is provided to each of the eight shielded wires 11.

A length of the portion covered by the heat shrinking tube 9 of the waterproofing portion 20 is approximately 20 mm. A length of a waterproofing agent filled portion 20a of the waterproofing portion 20 is approximately 10 mm. The waterproofing agent filled portion 20a is a portion difficult to bend with an increased outer diameter.

Of the eight shielded wires 11, five shielded wires 11a to 11e are grouped into a first group G1 and three shielded wires 11g to 11i are grouped into a second group G2, as shown in FIG. 3.

Of the shielded wires 11a to 11e in the first group G1, the waterproofing agent filled portion 20a of the waterproofing portion 20 of the shielded wire 11a is provided at 80 mm from the front end of the shielded wire 11a. The waterproofing agent filled portion 20a of the shielded wire 11b is positioned at 10 mm from the waterproofing agent filled portion 20a of the shielded wire 11a.

Specifically, the cut-off position P1 of the shielded wire 11a is positioned at 90 mm from the front end and the cut-off position P1 of the shielded wire 11b is positioned at 100 mm from the front end.

Similarly, the cut-off positions P1 of the shielded wires 11c, 11d, and 11e are provided sequentially at 10 mm apart. The cut-off position P1 of the shielded wire 11e is positioned at 130 mm from the front end.

Thereby, the front end positions of the waterproofing agent filled portions 20a of the waterproofing portions of the five shielded wires 11a to 11e in the first group G1 are each positioned at 10 mm apart such that the waterproofing agent filled portions 20a do not overlap in a radial direction.

Of the three shielded wires 11g to 11i in the second group G2, the waterproofing agent filled portion 20a of the waterproofing portion 20 of the shielded wire 11g is positioned at 80 mm from the shielded wire 11e in the first group G1. Thus, the cut-off position P1 of the shielded wire 11g is positioned at 210 mm from the front end. The waterproofing agent filled portions 20a of the shielded wires 11h and 11i are each positioned at 10 mm apart, similar to the first group G1. The cut-off position of the shielded wire 11i is positioned at 230 mm from the front end. The maximum peeling length of the shielding layer 3 and the outer casing 4 of the shielded wire is preferably 300 mm. Thus, a peeling length of 230 mm is within the tolerance.

The waterproofing portions 20 are provided to the shielded wires 11 included in the wire harness 10 as above. In the present embodiment, however, waterproofing portions are not provided to the wires 12 other than the shielded wires.

In the wire bundle included in the branch wire 10A of the wire harness 10, the waterproofing agent filled portions 20a, which are hardened with increased outer diameters, of the waterproofing portions 20 of the eight shielded wires 11a to 11i are provided at 10 mm apart from one another within the first group G1 and the second group G2, as described above. Since the waterproofing agent filled portions 20a do not overlap with one another, only one waterproofing agent filled portion 20a of the waterproofing portion 20 is provided in a cross section of the same wire harness 10. In addition, a section of 80 mm is provided between the first group G1 and the second group G2. Thus, there is no waterproofing portion 20 in the section.

As described above, the waterproofing agent filled portions hardened with increased outer diameters of the waterproofing portions 20 are dispersed in the axis direction without being overlapped in the branch wire 10A. Thus, flexibility is hardly reduced in both locations of the first group G1 and the second group G2. In addition, there is no waterproofing portion in the section M between the first group G1 and the second group G2, thus completely eliminating reduction in flexibility. Accordingly, when the branch wire 10A is bent, the portions of the first group G1 and the second group G2 can be bent with no effort at the section M as a bend support. Thus, routing performance of the wire harness is not adversely affected.

Furthermore, the waterproofing agent filled portions 20a of the waterproofing portions 20 do not overlap in the radial direction, thus preventing the outer diameter of the branch wire 10A from locally increasing. In a case where the branch wire 10A is covered by the corrugated tube 30 for protection, the corrugated tube 30 does not need to increase in size and the branch wire does not need an extra space for routing.

FIG. 4 illustrates a modification of the embodiment above, where the number of shielded wires 11 is reduced to six.

In this case, positions are shifted for the entire length of the waterproofing portion 20. Shielded wires 11a to 11c are grouped into a first group G1 and shielded wires 11d to 11f are grouped into a second group G2. In the first group G1, the waterproofing portions 20 of the shielded wires are provided at 20 mm apart. The shielded wires are positioned similarly in the second group G2. The first group G1 and the second group G2 are also provided at 80 mm apart.

### REFERENCE SIGNS LIST

1, 11: Shielded wire
2: Core wire
3: Shielding layer
4: Outer casing
7: Waterproofing agent
9: Heat shrinking tube
10: Wire harness
10A: Branch wire
20: Waterproofing portion
20a: Waterproofing agent filled portion
30: Corrugated tube
P1: Cut-off position

1. A wire harness waterproof structure comprising plural groups of shielded wires in a wire bundle included in a wire harness, wherein each of the shielded wires has a waterproofing portion;
the waterproofing portions of shielded wires in each group being provided at different locations; and
the waterproofing portions of shielded wires in each group being provided at a predetermined distance from the waterproofing portions of shielded wires in another group so as to be disposed dispersedly in an axial direction of the wire harness.

2. The wire harness waterproof structure according to claim 1, wherein the predetermined distance from the waterproofing portions is at least 50 mm.

3. The wire harness waterproof structure according to claim 1, wherein
the waterproofing portions of the shielded wires are each filled with a waterproofing agent on cut-off end surfaces of a shielding layer enclosing a plurality of core wires of the shielded wires and an outer casing enclosing the shielding layer; and
a heat shrinking tube is covered on an outer periphery including the cut-off end surfaces from the outer casing to a portion filled with the waterproofing agent.

4. The wire harness waterproof structure according to claim 1, wherein there are two groups of shielded wires and the predetermined distance between the waterproofing portions of the shielded wires in the groups is from 50 to 80 mm.

5. The wire harness waterproof structure according to claim 4, wherein the plurality of shielded wires in one group are each provided at approximately 10 mm apart from the portion filled with the waterproofing agent of the waterproofing portion.
